(19) United States
(12) Patent Application Publication
(10) Pub. No.: US 2008/0249964 A1
(43) Pub. Date: Oct. 9, 2008

(54) Method for providing a refund for indicium-based postage

(75) Inventors: Mark Ferraro, Hamden, CT (US); Donald Eager, Milford, CT (US)

Correspondence Address: Townsend and Townsend and Crew LLP, Two Embarcardero Center, San Francisco, CA, 94111-3834, US

(73) Assignee: Neopost Technologies

(21) Appl. No.: 11/783,360

(22) Filed: Apr. 9, 2007

(51) Int. Cl. G06F 19/00

(52) U.S. Cl. 705/410

(57) ABSTRACT

A refund processing system and method where mailpiece identification information carried in first indicia is embedded in second indicia. Second indicia are stored in a database. A refund processor receives a request for a refund that includes identifiers of mailpieces for which a postage refund is sought. The refund processor determines if a corresponding second indicia is stored in the database, if any such indicia is authentic and monitors the mailstream to determine if any mailpiece corresponding to the identifier in the refund request is processed by the carrier. If an authentic second indicia is found that corresponds to the mailpiece and the mailpiece identifier is not detected in the mailstream, the refund is processed and the requester's account is credited to an amount equal to the postage borne by the second indicia.

### FIELD OF THE INVENTION

The field of the invention is information-bearing indicia and in particular the use of such indicia on mail pieces.

### BACKGROUND OF THE INVENTION

FIG. 1 shows prior art showing the placement of postal indicia on a mailpiece. A letter 101 includes a first portion 102 having an alphanumeric destination address 103 surmounted by a PLANET code 104 above and a POSTNET code 105 below. An Information Based Indicia 106 bearing a postage amount is shown in the upper right.

A PLANET code 104 is a barcode that is either 12 or 14 digits long that identifies mailpiece class and shape, the Confirm Subscriber ID and can includes up to 6 digits of additional information that the Confirm subscriber chooses, such as a mailing number, customer identifier, mailpiece identifier, etc. It ends with a check digit.

A POSTNET code 105 is a barcode that includes the destination ZIP Code, ZIP+4 Code, and the delivery point code.

The information contained in a PLANET and POSTNET code (as well as other information) can be represented by a OneCode. A OneCode is a barcode that can be 20, 25, 29, or 31 digits long, depending on the type of ZIP code present. Each digit has four possible states, so each vertical element of the OneCode can represent a number from zero to three.

An IBI 106 includes a 2-dimensional machine-readable bar code part 107 and a human-readable part 108. The machine readable part includes data such as the point of origin, postage amount, an authentication code and a certain number of unallocated bytes 109 that can be used to store additional information that the customer chooses. The postage amount embodied in an IBI is paid for by the customer. Once the IBI is imprinted on a mailpiece, it functions like a traditional postage stamp. Like a postage stamp, when an IBI is lost or destroyed, its value is generally lost by the customer.

The United States Postal Service (USPS) can scan indicia placed on a mailpiece when it processes the mailpiece. As used herein, an “indicium” (plural, “indicia”) is any machine-readable code carried by a mailpiece. Examples of indicia include PLANET, POSTNET, OneCode, IBI and other bar codes. An indicium can also be instantiated in other forms, such as a Radio Frequency Identifier (“RFID”).

Authorized refund processors are provided access to the data scanned by the USPS via the USPS mailstream. Using the mailstream, an authorized refund processor can determine which indicia have been scanned by the USPS, when, the status of a mailpiece, etc.

Indicia can be generated and printed at a customer premise by known mailing systems, such as the Neopost IJ-80-90-110 series of mailing systems. These systems include document and envelope feeders, weighers and franking subsystems. A franking subsystem interacts with a Postal Security Device to obtain a token that can be used to print an IBI on a document or an envelope to be mailed. These mailsystems can also generate and print PLANET, POSTNET and OneCodes on mailpieces. Sometimes, a series of mailpieces having postage indicia (such as an IBI) will be generated by a customer by mistake. This can occur, for example, when the wrong document is generated and inserted into envelopes, when a printing error occurs and the document being mailed is defective or out of date, etc. In other situations, a customer will simply change its mind and decide not to proceed with mailing whose mailpieces have already been generated. Consequently, the customer would like to obtain a refund for the postage on the defective mailpieces. What is needed is an efficient and reliable way for the customer to obtain a refund for a mailpiece that was never mailed.

### BRIEF DESCRIPTION OF THE DRAWINGS

FIG. 1 is a prior art depiction of a document bearing indicia relevant to mailing.

FIG. 2 is an embodiment of a system in accordance with the present invention.

FIG. 3 is an embodiment of the first part of the method in accordance with the present invention.

FIG. 4 is an embodiment of the second part of the method in accordance with the present invention.

FIG. 5 is an embodiment of an apparatus in accordance with present invention

### DETAILED DESCRIPTION

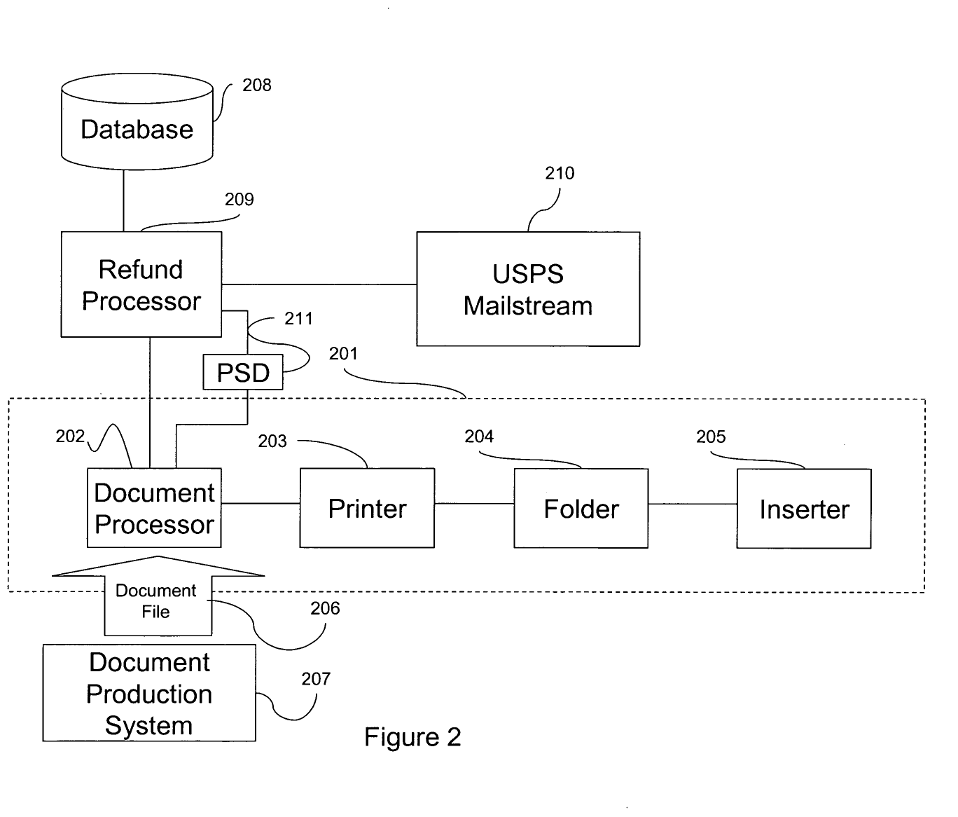

A system in accordance with an embodiment of the present invention is shown in FIG. 2. Mailing system 201 can include a document processor 202, a printer 203 and mail finishing equipment, such as a folder 204, an inserter 205, etc. Document processor 202 can generate indicia for a document to be mailed based upon information derived from an electronic version of the document as it occurs in an electronic file 206 of one or more documents. The electronic document file 206 can be received from a document production system 207, e.g., one that produces individually addressed letters soliciting charitable donations. The indicia generated for each document can be electronically merged into the document by document processor 202. Alternatively, one or more indicia may be provided to printer 203 separately from the pertinent document. The indicia generated may include a POSTNET, PLANET, OneCode and IBI. For example, a POSTNET code and an IBI may be printed on a portion of the page that, when folded, is designed to be seen through a window in a properly configured envelope.

The indicia may be derived from information contained in the document file in any suitable way. For example, document processor 202 can calculate the correct postage for a mailpiece based upon the destination and weight of a mailpiece that includes a document in the file. The destination address information can be derived by analyzing the destination address text at the beginning of the document. The weight can be calculated by determining the number of pages of the document in the file, multiplying the number of pages by the known weight of each sheet of paper on which the document is to be printed and adding the weight of the ink and the envelope. The destination and weight data can be used to calculate the correct postage.

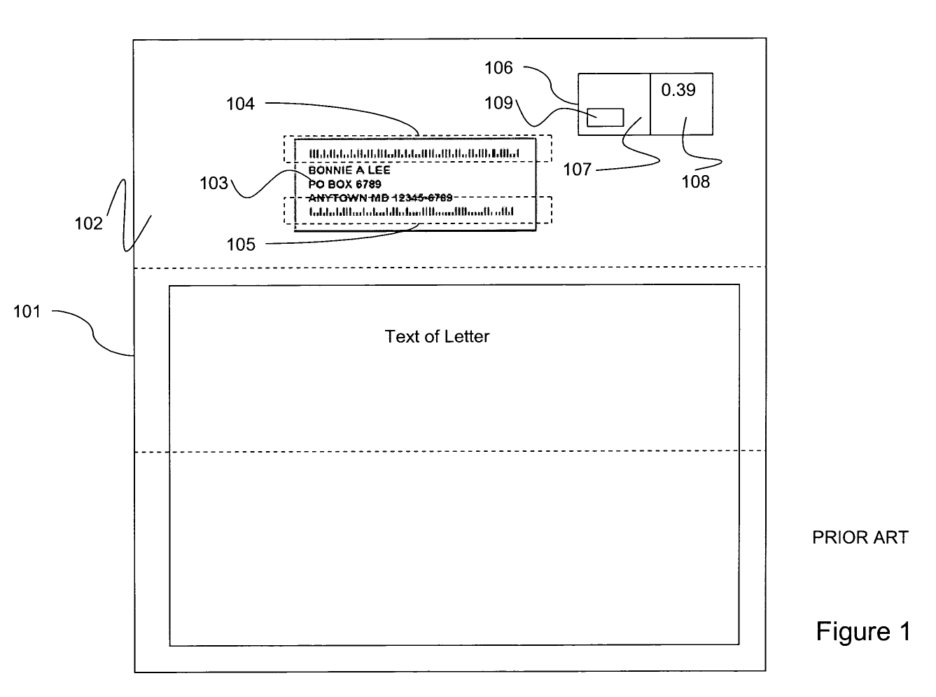

In accordance with an embodiment of the present invention, document processor 202 can derive a mailpiece identifier based upon the PLANET or OneCode generated for the mailpiece. For example, the document processor can hash the value of part or all of the PLANET code, hash all or part of the POSTNET code combined with all or part of the PLANET code, etc. The document processor can embed this mailpiece identifier into the unallocated bytes of the discretionary portion 109 (FIG. 1) of the IBI. The mailpiece identifier can link the PLANET and possibly the POSTNET code to the IBI generated for the same mailpiece. Likewise, the mailpiece identifier may be derived by hashing or otherwise digesting all or part of the OneCode or other indicia generated for or otherwise associated with the mailpiece. Document processor 202 can also encode postage into the IBI using PSD 211, as known in the art.

An authentication code such as a digital signature can be generated for the IBI, of which the mailpiece identifier can be a part. The authentication code can be included in the IBI or be separate and be associated with the IBI. For example, the authentication code can be stored with the mailpiece identifier that can be included in the IBI. The mailpiece identifier can act as a key that links the authenticator with the IBI that it can authenticate. The authentication code can be generated in a secure manner, e.g., by a tamper resistant component of document processor 202. It can reliably link an identifier of a mailpiece on which the IBI was placed to the IBI itself.

A copy of the IBI generated for each document can be stored in a database 208. The database can be co-located with the customer's mailing system 201 or be located at a refund processor 209. For example, the IBIs generated by mailing system 201 for a mailpiece production run at the customer's premises can be sent through a network (such as the Internet, an extranet, a WAN, etc., not shown) to refund processor 209, which can store the IBIs in database 208.

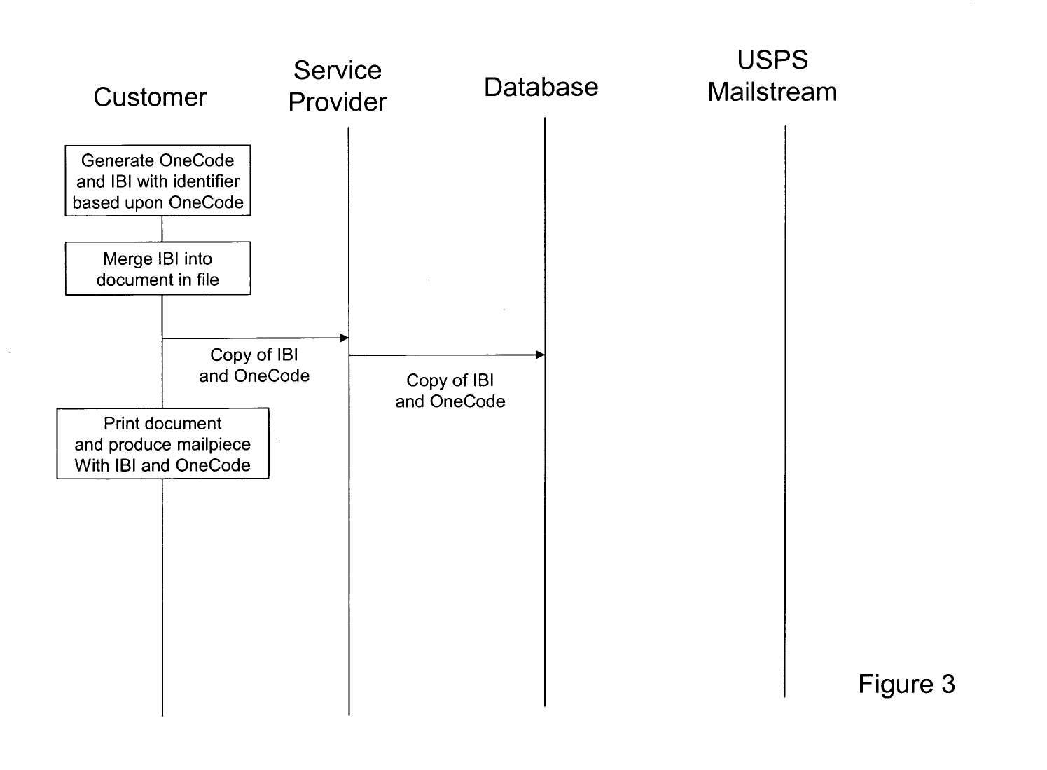

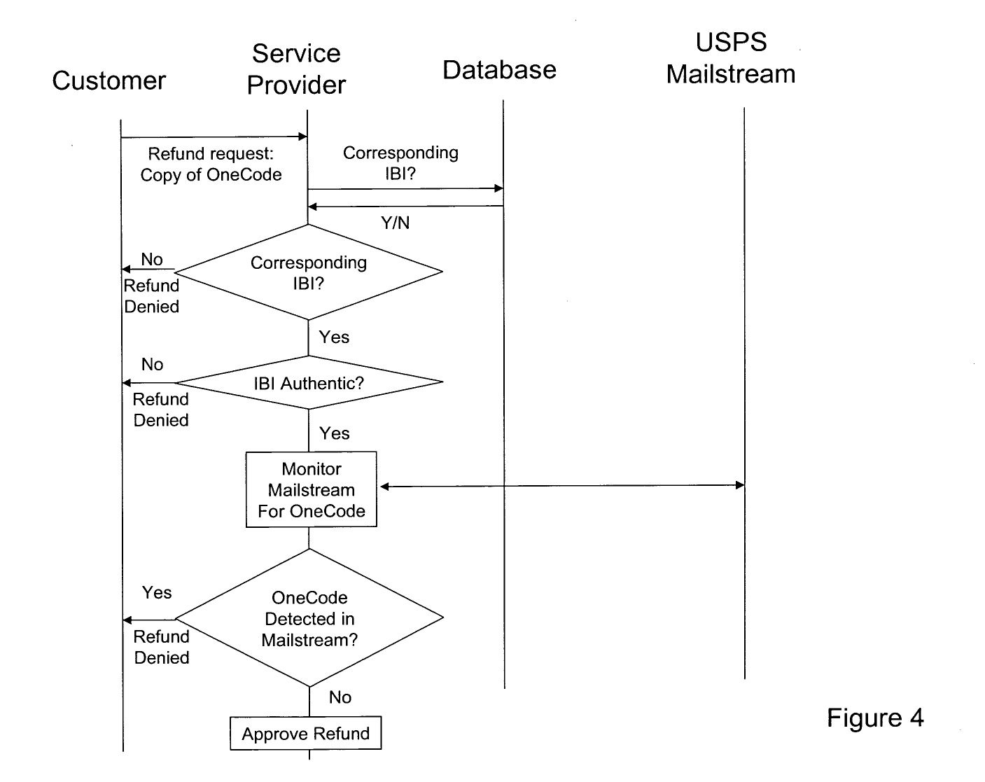

The method in accordance with an embodiment of the present invention is shown in FIG. 3 and continued in FIG. 4. The customer may decide that it doesn't want to use certain mailpieces on which an IBI has been placed, e.g., due to a defective production run, improperly printed individual mailpieces, etc. The customer would like to receive a refund for the postage amount reflected in the IBI for each defective mailpiece. In accordance with an embodiment of the present invention, the customer can provide information to the refund processor 209 based upon the PLANET or OneCode for each defective mailpiece. This can be done by running the defective mailpieces through a scanner, by designating certain PLANET codes or OneCodes out of a list of such indicia stored in a computer, etc., and sending them through a network to refund processor 209. Alternatively, the same information used to generate the mailpiece identifier embedded in the IBI of the defective mailpiece may be calculated (e.g., on the same basis on which it was calculated to derive the identifier, e.g., based upon all or part of the PLANET, OneCode and POSTNET indicia) and sent to the refund processor 209. In any event, sufficient information should be sent to refund processor 209 to permit refund processor 209 to determine if an IBI corresponding to the mailpiece is stored in database 208. For example, if the mailpiece identifier is sent to refund processor 209, refund processor can search database 208 to determine if an IBI exists that includes in its discretionary part 109 (FIG. 1) the same identifier. If such an IBI is found by refund processor 209, it means that an IBI was generated for and placed on the mailpiece for which a refund has been requested by the customer. If no such IBI is found, it means that there is no record that an IBI was generated for the identified mailpiece, i.e., that the customer paid for postage for such a mailpiece, and the refund request can be denied.

The security of the IBI should be checked to ensure that it hasn't been tampered with. For example, an unscrupulous party could alter the mailpiece identifier in the IBI after it was printed on a mailpiece and before it is sent to refund processor 209. The new, false identifier could correspond to that of a mailpiece on which no IBI was placed. The unscrupulous party could then submit a request for a refund based upon the false identifier and the refund processor would find the IBI with that identifier in database 208 and possibly authorize an improper refund. To prevent such fraud, service provide can check the authentication code corresponding to an IBI found in database 208 that corresponds to an identifier submitted with a refund request. For example, the authentication code can be verified by verifying a digital signature of the IBI made using a private key stored in a tamper resistant portion of document processor 202. Alternatively, a cryptographic hash of the IBI can be verified using a shared, secret cryptographic key used in the hash. Such a key could be shared by the PSD 211 and refund processor 209. Any suitable authentication system can be used for this purpose. If the authentication code is successfully verified, then the IBI (and the mailpiece identifier it contains) can be considered authentic. If not, then the IBI can be considered to be corrupted and a refund request may be denied.

A customer can submit a valid refund request for which a corresponding and authentic IBI is found in database 208 and then mail the mailpiece. In that case, the customer can receive a refund and also have the mailpiece delivered for free. To prevent such an occurrence, refund processor 209 can monitor the USPS (or other carrier) mailstream 210 for the occurrence of a mailpiece for which a refund request has been submitted. The occurrence of a PLANET code or OneCode, for example, of a mailpiece for which a refund request has been submitted would indicate that the mailpiece has been mailed. In that case, the refund request can be denied. The mailstream 210 can be monitored for a mailpiece given period of time after the refund request has been received, e.g., five days, a week, etc. If the mailpiece is detected during this period of time, then the refund request can be denied. If no such mailpiece has been detected at the end of the period of time, then the refund request may be approved. When a refund is approved, a customer account (e.g., the PSD, another credit account, etc.) can be credited an amount equal to the postage borne by the second indicia placed on the mailpiece for which a refund was requested.

In summary, if an IBI is found in database 208 containing a mailpiece identifier corresponding to one submitted in a refund request, and if the IBI is determined to be authentic, and if the mailpiece identifier is not found in the mailstream 210, then the refund request can be approved.

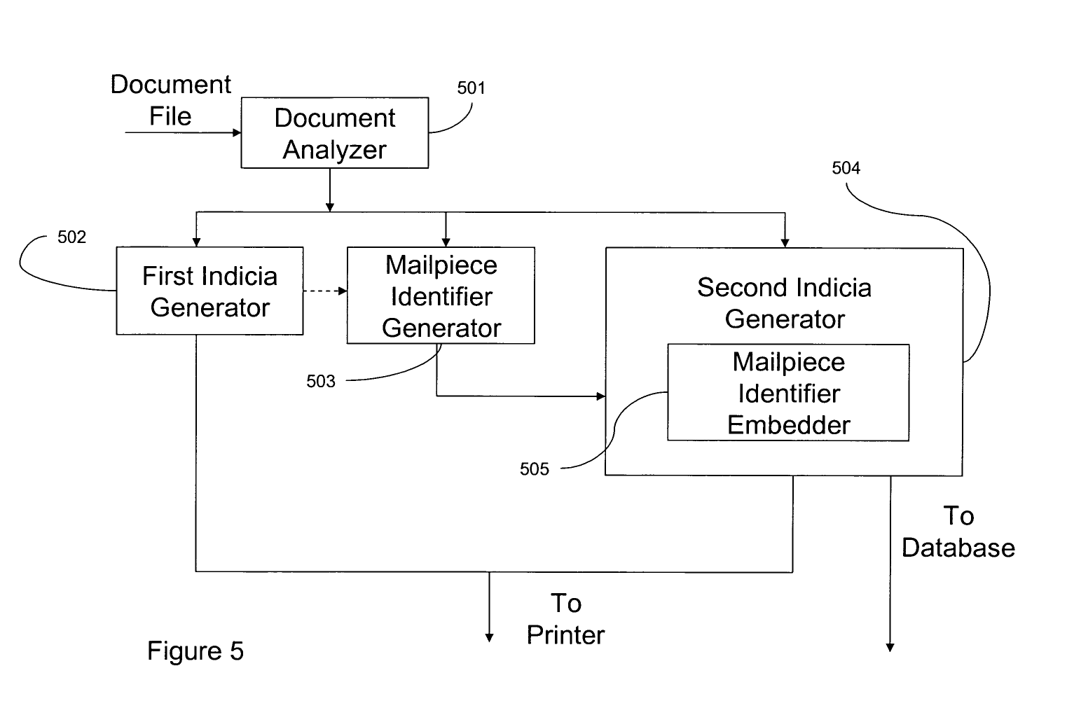

An embodiment of an apparatus in accordance with the present invention is shown in FIG. 5. Document analyzer 501 receives a document file containing one or more electronic versions of documents to be mailed. One or more documents are analyzed for information needed to generate indicia and an identifier for the mailpiece that will be produced from the document. The results of the analysis are sent to first indicia generator 502, which can generate indicia such as a PLANET code, a OneCode, a POSTNET code, etc. The results of the analysis can also be sent to mailpiece identifier generator 503, which uses the results to generate the identifier. Alternatively or in conjunction with receiving the output from the document analyzer 501, indicia or indicia information can be sent from first indicia generator 502 to mailpiece identifier generator 503. This is indicated by the dotted arrow. Information from the document analyzer 501 and the mailpiece identifier generator 503 can be sent to second indicia generator 504. Second indicia generator 504 can include mailpiece identifier embedder subsystem 505, which embeds the mailpiece identifier into the second indicia. Second indicia can also be generated using information from document analyzer 501. This apparatus can be embodied in document processor 202 in FIG. 2.

Document processor 202 can include a document electronic processor coupled to a memory storing document processing instructions adapted to be executed by the document electronic processor. The document electronic processor can be a general purpose microprocessor, such as the Intel Quad Core Xeon processor. The document electronic processor can also be an Application Specific Integrated Circuit (ASIC) that embodies part or all of the method in accordance with an embodiment of the present invention in hardware and firmware. Memory can be any device capable of storing digital information, such as RAM, ROM, a hard disk, flash memory, a CD, etc. The document processing instructions can be adapted to be executed by the document electronic processor to receive a document file, analyze a document in the document file for information sufficient to generate first indicia (such as one or more of a POSTNET, PLANET, OneCode, etc.) and a mailpiece identifier that is linkable to (e.g., based upon) the first indicia. The document processing instructions can also cause the document electronic processor to generate a second indicia (such as an IBI) in which the mailpiece identifier is embedded. The instructions can also cause the document electronic processor to merge the generated indicia into the document and/or otherwise associate one or more indicia with the document and send a copy of the second indicia to be stored in a database. The instructions can also be executed to cause the indicia and/or the document to be printed. The electronic instructions can also be executed to cause the document electronic processor to generate a refund request that can include mailpiece identifier information, such as one or more first indicia, information derived from first indicia, etc., and send the refund request to refund processor 209.

Refund processor 209 can include a refund electronic processor coupled to a memory storing refund instructions adapted to be executed by the refund electronic processor. The refund electronic processor can be a general purpose microprocessor, such as the Intel Quad Core Xeon processor. The refund electronic processor can also be an Application Specific Integrated Circuit (ASIC) that embodies part or all of the method in accordance with an embodiment of the present invention in hardware and firmware. Memory can be any device capable of storing digital information, such as RAM, ROM, a hard disk, flash memory, a CD, etc. The refund instructions can be adapted to be executed by the refund electronic processor to receive second indicia or information derived from second indicia and store it in a database, as well as to receive a refund request that includes mailpiece identifier first indicia or mailpiece identification information derived from first indicia. The refund instructions can be executed to cause a lookup of an IBI in a database based upon the mailpiece identification information, to verify the authentication code of an IBI if one is found and to monitor the mailstream for evidence that a mailpiece bearing indicia that correspond to the mailpiece identifier has been processed. If a corresponding IBI is found and authenticated, and if the mailpiece identification information is not found in the mailstream, then the refund instructions can cause the refund electronic processor to credit a refund to an account of the refund requester, e.g., of an amount equal to the postage borne by the corresponding IBI.

First and second indicia may occur in various configurations in accordance with embodiments of the present invention. First indicia can be separate and distinct from second indicia. For example, first indicia may be a two state or four state bar code, such as a PLANET code and OneCode, respectively, while the second indicia may be in a different format, such as a two dimensional bar code, like an IBI. Alternatively, at least some of the first and second indicia may occur in the same format. First indicia may be placed on a mailpiece in different locations than the second indicia. For example, a PLANET code may occur at the bottom of an envelope under the printed address, while the IBI may occur in the upper right hand corner. Alternatively, in some embodiments, first and second indicia may be combined into a single printed mark or be two contiguous portions of a single mark. Alternatively, an indicium may take the form of a RFID or some other device for carrying information.

If the first and second indicia are embodied as a single indicium, e.g., a single, two-dimensional bar code, then an embodiment of the present invention can operate in a similar fashion to the embodiments described above. A single indicium containing postage, destination information and other information (such as an authentication code) can be disposed by a mailing system on a mailpiece by a customer. A copy of the indicium can be stored in a database. If the customer decides not to mail the mailpiece and wants to receive a refund for the postage embodied in the single indicium, the customer can submit a refund request to a refund processor. The refund request can include a mailpiece identifier based upon the information contained in the single indicium. For example, such the identifier can be a mailpiece identifier taken from the single indicium, a hash of all or some of the information contained in the indicium, etc. The refund processor can determine if a single indicium that corresponds to the mailpiece identifier is stored in the database. If it is, the refund processor can authenticate the stored indicium. If the indicium is successfully authenticated, the refund processor can monitor the carrier mailstream to determine if a mailpiece bearing the single indicium has been processed by the carrier. If no such mailpiece is detected (e.g., after a given period of time), then the refund request can be approved and the refund processor can cause an account to be credited accordingly.

Although the USPS was used to describe various embodiments of the present invention, one of skill in the art will recognize that the present invention can be used with any carrier, such as UPS, Federal Express, DHL, etc., that uses indicia to facilitate the delivery process and that makes available, directly or indirectly, a record of items that have been processed. For example, a carrier may accept queries that include mailpiece identifiers to a carrier database that stores identification information of mailpieces that have been processed.

The foregoing is meant to illustrate and not limit the scope of the present invention. Those of skill in the art will understand that the above description encompasses other embodiments that can fall within the scope of the claims. For example, many indicia can be used on a mailpiece, some or all of which encode information from some or all of the other indicia. Indeed, in some embodiments, an indicium on one mailpiece can encode information from one or more indicia on another mailpiece. Likewise, a two indicium can include information encoded from each other. That is, on a mailpiece that includes a first indicium and a second indicium, the first indicium can include an encoded hash of the information contained in the second indicium and the second indicium can contain an encoded hash of information contained in the first indicium.

What is claimed is:

1. A method for processing a refund request for a mailpiece, comprising:
identifying a second indicium that corresponds to mailpiece identification information included in the refund request;
verifying an authentication code of the identified second indicium;
determining if the mailpiece has been processed by a carrier based upon the mailpiece identification information received in the refund request; and
responsive to the result of the determining step, approving a refund for the mailpiece if the authentication code of the second indicium is successfully verified and the mailpiece is determined not to have been processed by the carrier.

2. The method of claim 1, wherein the second indicium is an IBI and the mailpiece identification information in the refund request is derived from a PLANET code or a OneCode.

3. The method of claim 1, wherein mailpiece identification information is derived from a first indicia placed on the mailpiece and wherein mailpiece identification information is embedded in the second indicia.

4. The method of claim 1, wherein the second indicia bears a postage amount and a requester account is credited an amount equal to the postage carried by the second indicia if the refund is approved.

5. A method for proving a refund for a mailpiece, comprising:
generating a first indicium;
generating a second indicium that bears a postage amount and includes a mailpiece identifier based upon information contained in the first indicium;
generating an authentication code and including it in the second indicium; and
sending a refund request for the mailpiece, the refund request identifying the mailpiece for which the refund is requested based upon information contained in the first indicium.

6. The method of claim 5, wherein the first indicium is a PLANET code or a OneCode and the second indicium is an IBI.

7. The method of claim 5, further comprising receiving a credit to an account equal to an amount of the postage of the second indicium.

8. A system for requesting a refund for a mailpiece, comprising:
a document processor that generates a first indicium and a second indicium, where the second indicium includes a mailpiece identifier based upon the information contained in the first indicium, that sends a copy of the second indicium to be stored in a database and that generates a refund request that includes a mailpiece identifier;
a refund processor that receives a refund request that includes a mailpiece identifier, identifies a corresponding second indicium that is stored in the database, authenticates the second indicium, monitors the mailstream of a carrier for the mailpiece identifier to determine if the mailpiece has been processed, and if the second indicium is authenticated and the mailpiece identifier is not detected in the mailstream, then causing an account to be credited an amount equal to the postage borne by the second indicium.

9. The system of claim 8, wherein the first indicium is a PLANET code or a OneCode and the second indicium is an IBI.

10. A system for generating a refund request, comprising:
a document analyzer that analyzes an electronic document to obtain mailing information and calculate the postage needed to mail a mailpiece based upon the electronic document;
a first indicium generator that encodes destination information into an indicium to be placed on the mailpiece;
a mailpiece identifier generator that generates a mailpiece identifier based upon the information contained in the first indicium created by the first indicium generator;
a second indicium generator that includes a mailpiece identifier embedder that encodes the mailpiece identifier from the mailpiece identifier generator into a second indicium and that encodes a postage amount into the second indicium.

11. The system of claim 10, wherein the first indicium is a PLANET code or a OneCode and the second indicium is an IBI.

12. A mailpiece including a first indicium and a second indicium, the first indicium placed on a first part of the mailpiece and the second indicium placed on a second part of the mailpiece, the first indicium and second indicium not being contiguous, the first indicium including an encoded hash of the information contained in the second indicium.

13. A symbol generated by the method of:
hashing information contained in a second indicium on a mailpiece; and
encoding the hash to be a part of a first indicium that is separate and distinct from the second indicium, the first indicium placed on the mailpiece in a different location than the second indicium.

14. A mailpiece including a N+1 indicia, not all of the N+1 indicia being contiguous, the N+1^{st} indicium including encoded hashes of the information contained in a plurality of the other N indicia.

15. A mailpiece including a first indicium and a second indicium first indicium placed on a first part of the mailpiece and the second indicium placed on a second part of the mailpiece, the first indicium and second indicium not being contiguous, the first indicium including an encoded hash of the information contained in the second indicium and the second indicium containing an encoded hash of information contained in the first indicium.
